(19) United States
(12) Patent Application Publication
(10) Pub. No.: US 2006/0013558 A1
(43) Pub. Date: Jan. 19, 2006

(54) Running time counter for a digital recording device

(76) Inventors: Vincent Skurdal, Boise, ID (US); Mark Brown, Boise, ID (US); Shane Gehring, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/894,134

(22) Filed: Jul. 19, 2004

(51) Int. Cl. H04N 5/781

(52) U.S. Cl. 386/46; 386/125

(57) ABSTRACT

A digital recording device comprising a running time clock or counter. The running time clock or counter is displayed on a viewfinder and/or recorded on video tape when the digital recording device is in record mode. The running time clock or counter indicates the time during which video is recorded, starting from the beginning of a recording session. The running time clock may be reset at the discretion of the user. The device may include an RF link to a game clock, and may record the game clock time in addition to, or in lieu of, the running time clock. The present invention may advantageously be used in conjunction with sporting events, time lapse recording applications and usability studies, for example.

### TECHNICAL FIELD

The present invention relates generally to digital recording devices.

### BACKGROUND

Camcorders are often used for recording sporting events. Some sports (like soccer) have a running clock and it is convenient to have a running display that can be stored with the sporting event's recording. Videographers may not want to record the entire game but may choose to record just the “live” play and stop the recording during dead time (ball out of bounds, substitutions) even though the master game clock is still running. The camcorder would have a button (or an easily accessible selection) to start the running time counter and it would run until the feature is turned off.

Current camcorders have the ability to turn on a time and date display. Some camcorders allow the time and date to be turned on during playback only. However, existing camcorders do not have the ability to provide the convenient “game” clock feature that displays the running time since the “Start button” was pressed.

### SUMMARY OF THE INVENTION

The present invention comprises a system embodied in a digital recording device that provides for a running time clock or counter. The running time clock or counter is displayed on a viewfinder and/or recorded on video tape when the digital recording device is in record mode. The running time clock or counter indicates the time during which video is recorded, starting from the beginning of a recording session. The running time clock may be reset at the discretion of the user.

Embodiments of the present invention may also employ an RF link between the digital recording device and a game clock for an event, so as to record the official game time of the event. The present invention may be used in time lapse filming or recording applications and usability studies, for example.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1-3 illustrate three views of an exemplary digital recording device in accordance with the principles of the present invention.

### DETAILED DESCRIPTION

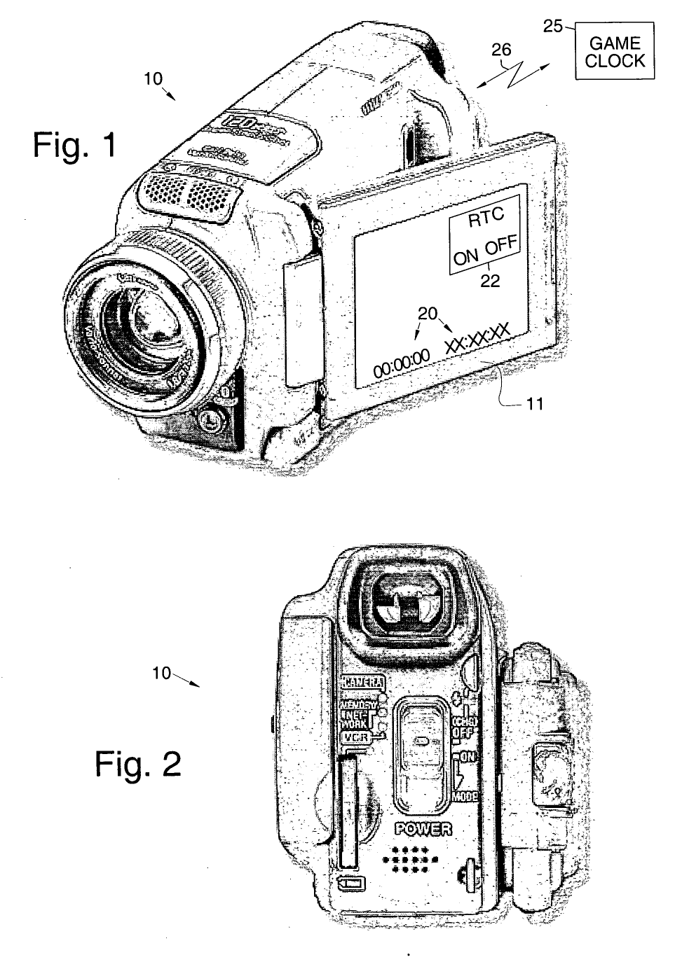

Referring to the drawing figures, FIGS. 1-3 illustrate angled, rear and top views, respectively, of an exemplary digital recording device 10 in accordance with the principles of the present invention. The exemplary digital recording device 10 that is illustrated is a digital camcorder 10. The basic design and operation of the digital camcorder 10 is well-known and will not be discussed in detail. Also, while the present is particularly well-suited for use with digital camcorders 10, for example, it may also be used with other digital recording devices 10 as well.

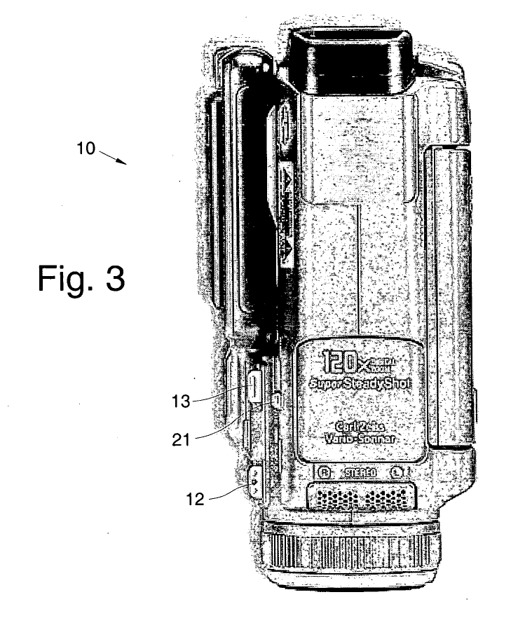

With regard to the present invention, the digital recording device 10 (camcorder 10) comprises a viewfinder 11 or display 11, which presents an image scene to a user that is viewed by the device 10 and which may be recorded. The digital recording device 10 includes a record (REC) button 12 (FIG. 3) that places the device in record mode and which is depressed when video is to be recorded by the device 10. The digital recording device 10 also includes a start/stop recording button 13 (FIG. 3) that is depressed to start and stop recording of video.

Depressing of the start/stop recording button 13 displays and/or records a running time counter (RTC) 20 in accordance with the present invention. The running time counter 20 records time from initiation of a recording session until recording is completed. Thus, the running time counter 20 is started when the record button is depressed and records elapsed recording time.

The camcorder 10, or other recording device 10, comprises a button 21 shown in FIG. 3, or a menu selection 22 shown in FIG. 1, that starts the running time counter 20. When the feature is started, the running time counter 20 is started on the camcorder. Whenever the record (REC) button 12 is pressed, the running time counter 20 is displayed and/or recorded onto a digital video tape or other video recording medium. Alternatively, the running time counter 20 may be stored on the tape and be selectively displayed during playback. Even when the record (REC) function is turned off, the running time counter 20 continues to run so that it will accurately time a “game” clock 25. The running time counter 20 may be reset by the user so that a new running time can be started.

Making and publishing quality video is becoming easier to provide as time goes by. Today, digital recording devices 10, such as camcorders 10, for example, are being used by amateur videographers to record many events. The video is then digitally downloaded to a computer, split into scenes and then combined into a video file. When performing this sequence of steps on certain types of events, having a running time counter can prove to be very useful. The present invention addresses this need.

The present invention solves a common problem created during the recording of certain types of events. Having the ability to turn on the running time counter 20 can be particularly useful for recording a soccer or other type of game, for example. When a user presses the start/stop button 13 on the digital recording device 10, the running time counter 20 is stored along with the video recording. Because there may be significant time lapse between recorded scenes, it is very convenient to have the “game” clock time available. Also, for the soccer example, knowing what the “game” clock value is may be useful to know as the half or game is about ready to expire. For example, if the user records the first minute of the game, presses the start/stop recording button 13 to stop recording video, and then waits twenty minutes for the next recorded scene, the video recording will show a running time of “00:00:00” to “00:01:00” for the first scene and then “00:20:00” to “XX:XX:XX” for the next scene.

Additional embodiments of the present invention are discussed below.

For sports that have a game clock 25 that starts and stops during the game, including events such as football, basketball and soccer, for example, an RF link 26 between the digital recording device 10 and the official game clock 25 may be provided. In this embodiment, the digital recording device 10 records official game time transmitted by the game clock 25 instead of, or in addition to, using the arbitrary time of the running time counter 20 under the control of the user.

The present invention may be employed in instances and applications other than sporting events. For example, the present invention may be used in time lapse filming or recording situations using the digital recording device 10, such as in filming plants growing or dying, solar eclipses, sunsets, or construction, and the like.

Another instance of use of the present invention relates to observing subjects for usability studies. In these situations, it is desired to make a determination as to how long it takes for a person to perform a particular task, such as set up a printer, for example. Upon initiation of the task, the running time counter 20 on the digital recording device 10 is started, which runs during performance of the task until recording is completed.. The time to complete the task may be used to analyze the person's performance relative to others performing the same task, along with evaluating problems encountered during performing the task. This allows the design of the printer, for example, to be evaluated, with a goal of improving its design.

Thus, digital recording devices that implement a running time counter have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A digital recording device comprising:
a display;
a video recording medium;
a record button that is depressed to place the device in record mode;
a start/stop recording button for starting and stopping recording of video; and
a running time counter that is started when the record button is depressed and which records elapsed recording time.

2. The device recited in claim 1 which comprises a digital camcorder.

3. The device recited in claim 1 wherein the running time counter is recorded on the video recording medium

4. The device recited in claim 1 wherein the running time counter is displayed on the display.

5. The device recited in claim 1 further comprising an RF link between the device and a game clock.

6. The device recited in claim 5 wherein the game clock time is recorded in lieu of the running time counter.

7. The device recited in claim 5 wherein the game clock time is recorded in addition to the running time counter.

8. The device recited in claim 1 which is used to time lapse record an event.

9. The device recited in claim 1 which is used to record and time actions of a person during a usability study.
